(19) United States
(12) Patent Application Publication
(10) Pub. No.: US 2025/0198233 A1
(43) Pub. Date: Jun. 19, 2025

(54) Corner Bracket for a Window Blind Frame

(71) Applicant: Louver-Lite Limited, Hyde Cheshire (GB)

(72) Inventor: Andrew Greening, Hyde Cheshire (GB)

(73) Assignee: Louver-Lite Limited, Hyde Cheshire (GB)

(21) Appl. No.: 18/851,787

(22) PCT Filed: Mar. 22, 2023
(86) PCT No.: PCT/GB2023/050731

§ 371 Date: Sep. 27, 2024

(30) Foreign Application Priority Data
Mar. 31, 2022 (GB) 2204696.5

(51) Int. Cl. E06B 9/38

(52) U.S. Cl. CPC E06B 9/38

(57) ABSTRACT

A snap-fit corner bracket for a window blind frame, the corner bracket including a central body element and extending from the central body element a first connector assembly and a second connector assembly, wherein the second connector assembly is angled relative to the first connector assembly; wherein each connector assembly includes a locating member; an engagement lug carried at the distal end of a resiliently deformable arm; a stop surface; and a skirt, wherein the resiliently deformable arm is spaced from the locating member and curves relative thereto; and wherein the skirt is spaced from the resiliently deformable arm and covers the stop surface.

The present invention relates to corner brackets and in particular to corner brackets for window blind frames.

It has become quite common for window blinds to be located within window blind frames. EP1727958 discloses an example of such a window blind frame. The use of a frame with a window blind provides an aesthetically pleasing arrangement and also addresses the technical problems of minimising light-strike around the sides and bottom of the blind substrate when the substrate is deployed and protecting the edge portions of the blind substrate in use.

Typically, the frame includes elongate frame members, which form the sides of the frame, and corner brackets which join adjacent ends of the frame members. The elongate frame members are cut to length and the ends are coupled to respective corner brackets via one or more fixings, such as screws.

However, such an arrangement can be time-consuming for the installer, as the screws have to be properly located and each screw tightened individually. The screws also add to the overall cost of the frame and the installation.

To address these problems, it is desired to produce “push-fit” type corner brackets that provide a secure locking arrangement without the need for separate fixings.

WO2018/055416 describes an example of a push-fit corner bracket for use with window blind frames. The described push fit corner bracket includes a planar locking plate which includes an outwardly projecting locking element. However, as a result of the relatively rigid nature of the locking plate, such an arrangement may result in a relatively poor coupling, for example if the manufacturing tolerances are high. In particular, the engagement of the locking element within a slot defined in a frame member may not result in a secure coupling.

It is therefore desired to provide a push-fit corner bracket which addresses this issue.

According to a first aspect of the invention, there is provided a snap-fit corner bracket for a window blind frame, the corner bracket including a central body element and extending from the central body element a first connector assembly and a second connector assembly, wherein the second connector assembly is angled relative to the first connector assembly; wherein each connector assembly includes a locating member; an engagement lug carried at the distal end of a resiliently deformable arm; a stop surface; and a skirt, wherein the resiliently deformable arm is spaced from the locating member and curves relative thereto; and wherein the skirt is spaced from the resiliently deformable arm and covers or overlies the stop surface.

The use of a curved resiliently deformable arm which carries the engagement lug provides a secure coupling despite potential size differences as a result of manufacturing tolerances. Thus, the curved resiliently deformable arm urges the engagement lug into engagement with a corresponding slot defined by a frame member and results in a positive engagement of the engagement lug with the slot. The curvature of the resiliently deformable arm allows for certain tolerances in the sizes of the components of the corner bracket and the frame member.

A further issue identified with known corner brackets is an unsightly gap between the stop surface portion of the bracket and the end of the respective frame member. This problem is addressed by providing the skirt which covers or overlies the stop surface. Thus, in use, the skirt will cover any gap defined between the stop surface portion of the corner bracket and a respective end of a frame member.

By spacing the skirt from the resiliently deformable arm, the skirt does not interfere in the engagement of the engagement lug with the corresponding slot defined by the frame member.

Thus, the invention as claimed provides a more positive coupling between the corner bracket and a frame member and it addresses the problem of unsightly gaps between the corner bracket and the respective frame members.

As noted above, the second connector assembly is angled relative to the first connector assembly. For example, the locating member of the second connector assembly may define a second axis and the locating member of the first connector assembly may define a first axis and the first and second axes may define between them an angle. This angle may be from 10° to 170°, for example, from 80° to 100°, or about 90°. As most windows are rectangular, the window blind frame is suitably also rectangular. Accordingly, the angle defined between the first and second axes is suitably a right angle.

As the corner bracket provides a push-fit, the engagement lug is suitably shaped to facilitate a push-fit action. Accordingly, it suitably includes a tapered leading edge. A tapered leading edge results in the deflection of the resiliently deformable arm as the respective connector assembly is urged into engagement with the respective frame member. When the engagement lug is aligned with a slot defined by the frame member, the deflective force is removed and the resiliently deformable arm is urged back to its rest configuration by the restorative energy stored in the arm. In order to prevent an unintended disengagement of the lug from the slot, the lug suitably also defines a rearward facing (i.e., at its trailing edge) shoulder. The rearward facing shoulder provides a stop surface which engages with a portion of the frame member that defines the slot to prevent or resist removal of the lug from the slot. Thus, as the trailing edge of the engagement lug is not sloped, it is not possible to disengage the engagement lug from the slot by urging the frame member in the reverse direction without manually deflecting the resiliently deformable arm such that the engagement lug is disengaged from the slot.

The resiliently deformable arm suitably extends in the same direction as the locating member, but is spaced therefrom. In an embodiment of the invention, the resiliently deformable arm curves away from the locating member. In this way, a wall of the frame member urges the resiliently deformable arm towards the locating member during the coupling step. In such embodiments, the engagement lug suitably projects from the resiliently deformable arm in a direction which is away from the locating member.

In a further embodiment of the invention, the central body element defines a depth dimension; a portion of the central body element defines the stop surface; the stop surface extends along the entire depth dimension; and the skirt covers the entire stop surface. The skilled person will appreciate that the depth dimension of the central body element is typically equal to a depth dimension of a respective frame member. Thus, in this embodiment, the skirt covers the entire stop surface and thus covers the entirety of any gap that may be defined between the stop surface of the corner bracket and a corresponding end portion of the frame member. Accordingly, the skirt renders any such gap invisible to a user.

In order to provide a more robust coupling between the corner bracket and a respective frame member, each of the locating members may include one or more crushable ribs. For example, the ribs may extend axially along a longitudinal axis defined by locating members. Furthermore, the ribs may be tapered, such that the frictional force exerted by the ribs as they are crushed increases as the locating members are urged into a corresponding channel defined by a frame member. Thus, the ribs may provide a friction fit between locating members and a channel within which the members are located, which is additional to the snap-fit coupling provided by the engagement lug.

The corner bracket may include a cover element. This may hide from view the outwardly facing joints between the corner bracket and the respective frame members. In such embodiments, the central body element may include a first cover connector; the cover element may include a second cover connector; and the cover may be detachably coupled to the central body element via the interengagement of the first and second cover connectors. For example, the first cover connector may comprise a resiliently deformable hook and the second cover connector may comprise a hook receiver, such as a loop or arch of material that receives and retains the hook.

In certain embodiments of the invention, the central body element includes two spaced-apart first cover connectors; and the cover includes two corresponding spaced apart second cover connectors, wherein the interengagement of the first cover connectors with the respective second cover connectors correctly aligns the cover with the central body element. Thus, the provision of two spaced apart connectors permits the correct alignment of the cover relative to the central body element.

It has also been found that providing a small air gap between the cover element and the central body element may be beneficial. Accordingly, the cover element and/or the central body element may include one or more spacer elements. The spacer elements suitably space a portion of the cover element from the central body element. This allows air circulation around the central body element. For example, the central body element of the corner bracket may carry or define one or more spacer elements.

According to a second aspect of the invention, there is provided a window blind frame comprising a pair of frame members having adjacent ends that are joined together by a snap-fit corner bracket according to the first aspect of the invention as defined anywhere herein, wherein each frame member includes a wall which defines therein a slot, and a channel-defining portion which defines a channel, wherein the channel-defining portion is spaced from the wall; the locating member of a respective connector assembly is located within the channel defined by each channel-defining portion of the frame member; an end face of each frame member contacts a respective one of the stop surfaces; the slot defined by each frame member wall receives therein a respective engagement lug; and the skirts cover the respective end portions of the frame members. For example, an end portion of the wall may be located between the resiliently deformable arm and the skirt. As noted above, the engagement lug forms a snap-fit coupling with the respective slot.

As noted previously, most windows have a rectangular perimeter. Accordingly, the frame suitably comprises four frame members having a rectangular arrangement, and wherein adjacent ends of the frame members are joined together by respective corner brackets.

According to a third aspect of the invention, there is provided a combination of a window blind frame according to the second aspect of the invention as defined herein and a window blind, wherein the window blind is secured to the window blind frame. The window blind suitably comprises a blind substrate which may be selectively deployed or retracted to cover or uncover an architectural opening.

The window blind of the third aspect of the invention may be a roller blind, a vertical blind, a Venetian blind, a Roman blind, a cellular blind or a pleated blind. Typically, the window blind may include a roller tube via which the blind substrate may be deployed or retracted. Alternatively, the window blind may include a headrail via which the blind substrate may be deployed or retracted. Thus, the roller tube or the headrail may be coupled to the window blind frame.

The skilled person will appreciate that the blind substrate may be in the form of a sheet of fabric material (e.g., in the case of a roller blind, a Roman blind or a pleated blind) or it may comprise a plurality of substrate elements, such as louvres (e.g., in the case of a vertical blind or a Venetian blind).

The skilled person will appreciate that the features described and defined in connection with the aspect of the invention and the embodiments thereof may be combined in any combination, regardless of whether the specific combination is expressly mentioned herein. Thus, all such combinations are considered to be made available to the skilled person.

An embodiment of the invention will now be described, by way of example only, with reference to the accompanying drawings in which:

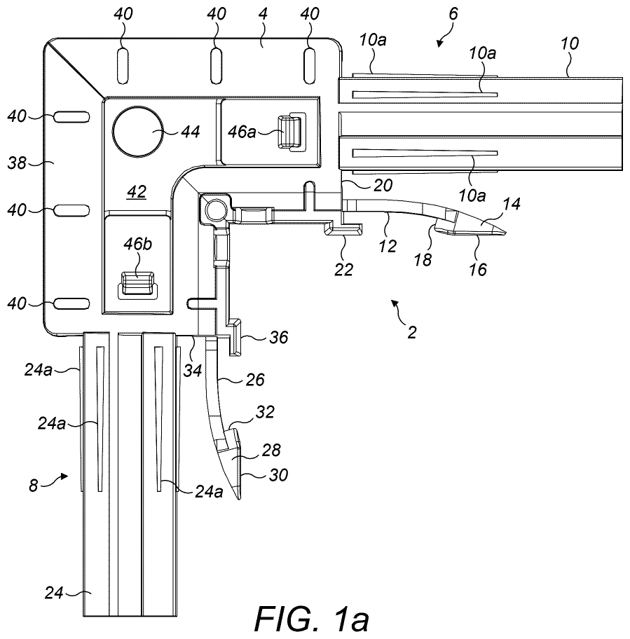

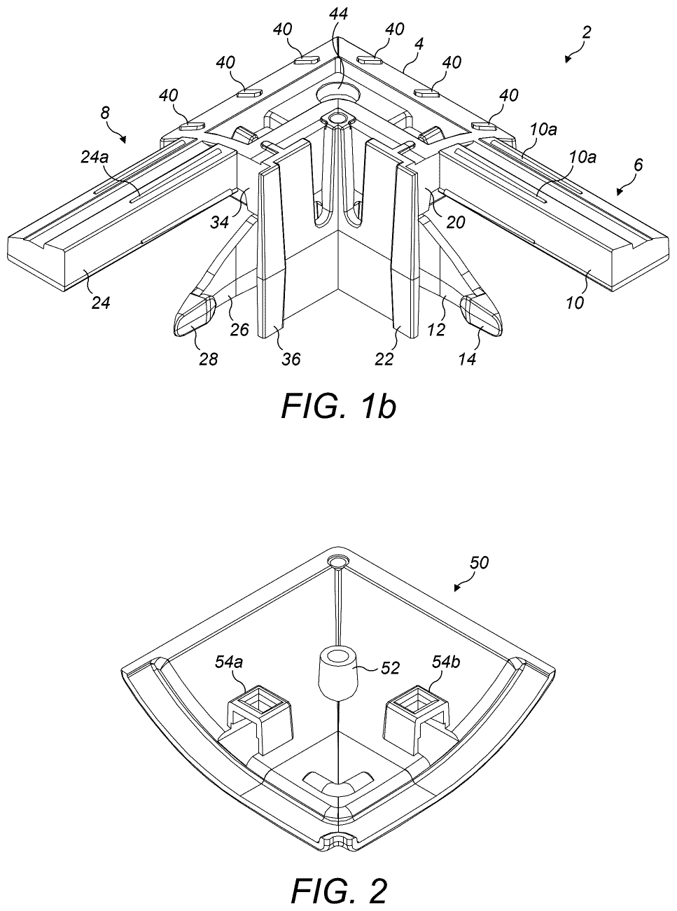

FIGS. 1a and 1b show a corner bracket according to the first aspect of the invention;

FIG. 2 shows a cover for use with the corner bracket shown in FIGS. 1a and 1b;

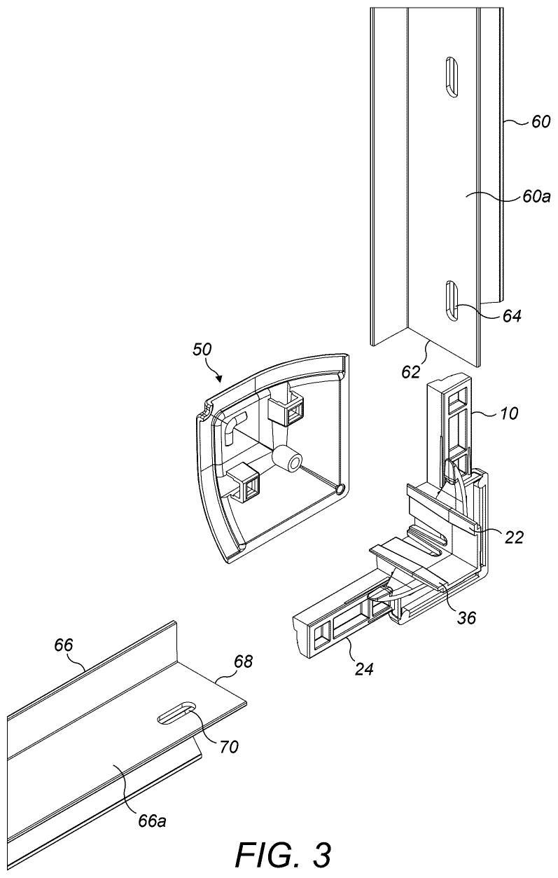

FIG. 3 shows an exploded view of a corner bracket as shown in FIGS. 1a and 1b, a cover as shown in FIG. 2 and a pair of frame members;

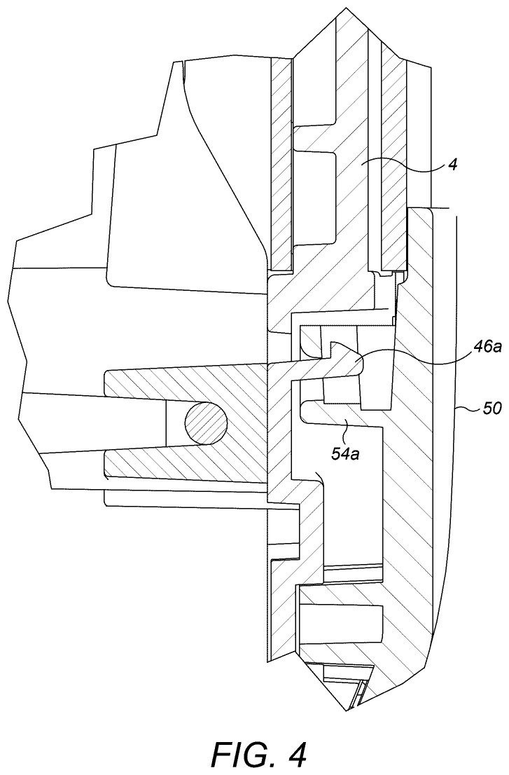

FIG. 4 shows a cross-sectional view through the corner bracket and the associated cover; and

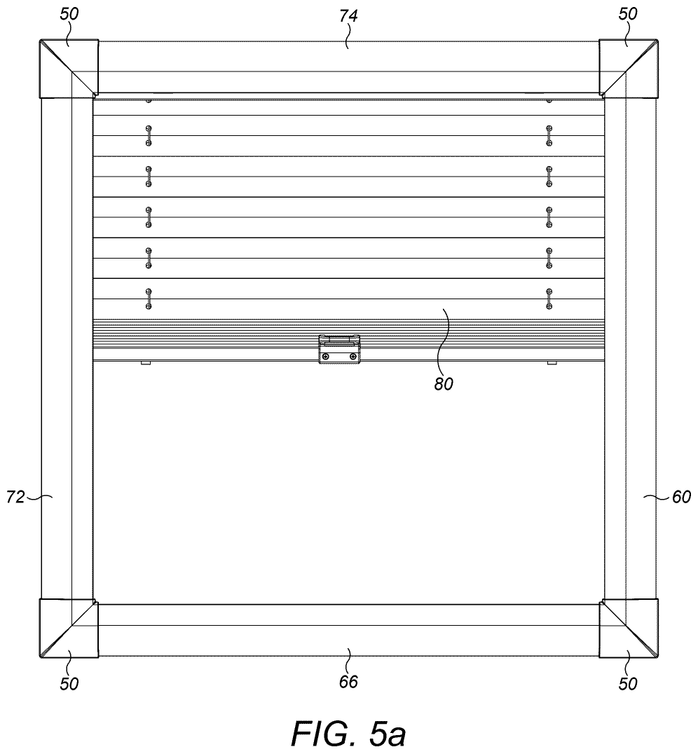

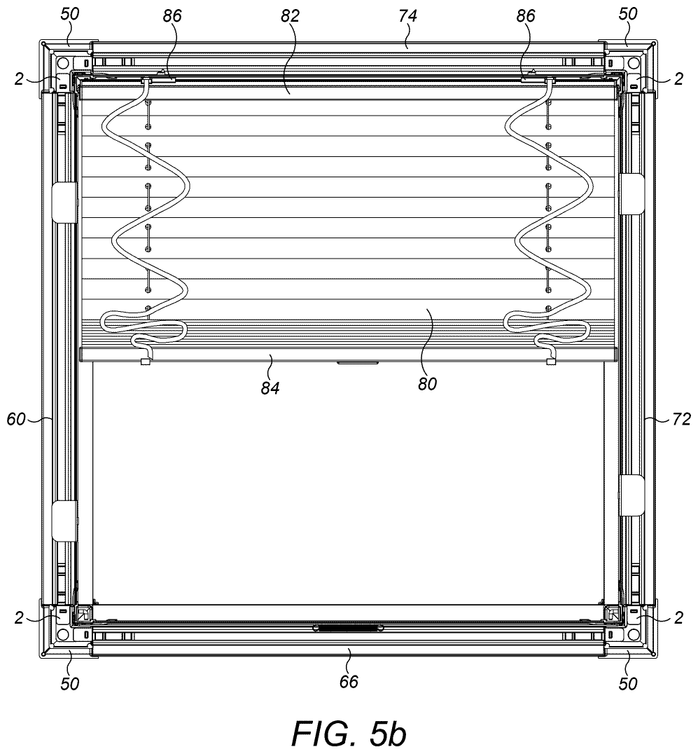

FIGS. 5a and 5b show a combination of a window blind frame and a window blind according to the third aspect of the invention.

For the avoidance of doubt, the skilled person will appreciate that in this specification, the terms “up”, “down”, “front”, “rear”, “upper”, “lower”, “width”, etc. refer to the orientation of the components as found in the example when installed for normal use as shown in the Figures.

FIGS. 1a and 1b show a corner bracket 2 which comprises a central body element 4, a first connector assembly 6 and a second connector assembly 8. As shown in FIGS. 1a and 1b, the second connector assembly 8 is angled at 90° relative to the first connector assembly 6.

The first connector assembly 6 includes a first locating member 10, which includes a plurality of crushable ribs 10a that extend in an axial direction. The crushable ribs 10a are tapered such that the distance by which they extend from the surface of the first locating member 10 increases towards the central body element 4. The first connector assembly 6 further includes a first curved, resiliently deformable arm 12 which carries at its distal end a first engagement lug 14. As shown in the Figures, the first engagement lug 14 includes a tapered leading edge 16 and a rear shoulder portion 18. The first arm 12 curves away from the first locating member 10. Finally, the first connector assembly 6 defines a first stop surface 20 and includes a first skirt 22 which overlies the first stop surface 20.

The second connector assembly 8 has a corresponding arrangement. Thus, the second connector assembly 8 includes a second locating member 24, which includes a plurality of crushable ribs 24a that extend in an axial direction. The crushable ribs 24a are tapered such that the distance by which they extend from the surface of the second locating member 24 increases towards the central body element 4. The second connector assembly 8 further includes a second curved, resiliently deformable arm 26 which carries at its distal end a second engagement lug 28. As shown in the Figures, the second engagement lug 28 includes a tapered leading edge 30 and a rear shoulder portion 32. The second arm 26 curves away from the second locating member 24. Finally, the second connector assembly 8 defines a second stop surface 34 and includes a second skirt 36 which overlies the second stop surface 20.

An upwardly facing surface 38 of the central body element 4 includes six upwardly projecting spacer elements 40. Additionally, a recessed portion 42 of the central body element 4 includes a circular locating aperture 44 and a pair of spaced-apart hook-shaped cover connectors 46a, 46b

FIG. 2 shows a rear view of a cover element 50, which has a curved rectangular profile. The cover element 50 includes a frustoconical locating element 52 and a pair of hook-receiving connector element 54a, 54b. In use, the cover element 50 overlies the corner bracket 2. The frustoconical locating element 52 is located within the circular locating aperture 44, the hook-shaped cover connector 46a is engaged with the hook-receiving connector element 54a, and the hook-shaped cover connector 46b is engaged with the hook-receiving connector element 54b.

FIG. 3 shows an exploded view of the corner bracket 2, the cover element 50 and a pair of frame members 60, 66.

The frame member 60 includes a transverse wall 60a, which is urged against the leading edge 16 of the first engagement lug 14. The tapered leading edge 16 causes the resiliently deformable first arm 12 to be deflected towards the first locating member 10. The frame member 60 is urged towards the central body portion 4 until an end surface 62 of the transverse wall 60a contacts the stop surface 20. In this arrangement, the first engagement lug 14 is aligned with an aperture 64 defined by the wall 60a. The first engagement lug 14 is urged to enter the aperture 64 by the restorative force stored in the deflected first arm 12. Any gap between the end surface 62 of the wall 60a and the stop surface 20 is covered by the first skirt 22.

The other frame member 66 has a similar arrangement as the first frame member 60. Thus, the frame member 66 includes a transverse wall 66a, which is urged against the leading edge 30 of the second engagement lug 28. The tapered leading edge 30 causes the resiliently deformable second arm 26 to be deflected towards the second locating member 24. The frame member 66 is urged towards the central body portion 4 until an end surface 68 of the transverse wall 66a contacts the second stop surface 34. In this arrangement, the second engagement lug 28 is aligned with an aperture 70 defined by the wall 66a. The second engagement lug 28 is urged to enter the aperture 70 by the restorative force stored in the deflected second arm 26. Any gap between the end surface 68 of the wall 66a and the stop surface 34 is covered by the second skirt 36.

The skilled person will appreciate that each of the frame members 60, 66 also includes respective channel-forming members (not shown). The channel-forming members define a channel which is sized and shaped to receive therein a respective one of the locating members 10, 24. The crush ribs 10a, 24a are crushed as the locating members 10, 24 are inserted into the respective channels such that the locating members 10, 24 form a friction fit within the respective channel.

FIG. 4 shows in more detail the engagement between the corner bracket 2 and the cover element 50. In particular, it shows the engagement of one of the hook-shaped cover connectors 46a and the corresponding hook-receiving connector element 54a.

FIGS. 5a and 5b show a combination of a window blind frame and a window blind according to the third aspect of the invention.

The window blind frame is formed from the frame members 60, 66 and further frame members 72, 74. The four frame members 60, 66, 72, 74 are arranged in a rectangular configuration and the adjacent ends of the frame members 60, 66, 72, 74 are coupled together by respective corner brackets 2.

Each of the corner brackets 2 is covered by a respective cover element 50.

A window blind substrate in the form of a pleated fabric 80 may be deployed or retracted to selectively cover the rectangular aperture defined by the window blind frame. As shown in FIG. 5b, the window blind further comprises a headrail 82 from which the pleated fabric 80 may be deployed, and a bottom bar 84 which is used to deploy or retract manually the pleated fabric 80.

The headrail 82 is secured to the top frame member 74 via headrail mounting brackets 86.

The combination of the window blind frame and the window blind may then be secured to a window or other architectural opening via known fixings and methods.

1. A snap-fit corner bracket for a window blind frame, the corner bracket including a central body element and extending from the central body element a first connector assembly and a second connector assembly, wherein the second connector assembly is angled relative to the first connector assembly; wherein each connector assembly includes a locating member; an engagement lug carried at the distal end of a resiliently deformable arm; a stop surface; and a skirt, wherein the resiliently deformable arm is spaced from the locating member and curves relative thereto; and wherein the skirt is spaced from the resiliently deformable arm and covers the stop surface.

2. A snap-fit corner bracket according to claim 1, wherein the angle between the first connector assembly and the second connector assembly is from 10° to 170°.

3. A snap-fit corner bracket according to claim 2, wherein the angle between the first connector assembly and the second connector assembly is from 80° to 100°.

4. A snap-fit corner bracket according to claim 1, wherein the engagement lug includes a tapered leading edge.

5. A snap-fit corner bracket according to claim 1, wherein the resiliently deformable arm curves away from the locating member.

6. A snap-fit corner bracket according to claim 1, wherein the central body element defines a depth dimension; a portion of the central body element defines the stop surface; the stop surface extends along the entire depth dimension; and the skirt covers the entire stop surface.

7. A snap-fit corner bracket according to claim 1, wherein the locating member, the resiliently deformable arm and the skirt all extend away from the central body element in the same direction.

8. A snap-fit corner bracket according to claim 1, wherein each of the locating members includes one or more crushable ribs.

9. A snap-fit corner bracket according to claim 1, wherein the bracket further includes a cover; the central body element includes a first cover connector; the cover includes a second cover connector; and the cover is detachably coupled to the central body element via interengagement of the first and second cover connectors.

10. A snap-fit corner bracket according to claim 9, wherein the first cover connector comprises a resiliently deformable hook and the second cover connector comprises a hook receiver.

11. A snap-fit corner bracket according to claim 9, wherein the central body element includes two spaced-apart first cover connectors; and the cover includes two corresponding spaced apart second cover connectors, wherein the interengagement of the first cover connectors with the respective second cover connectors correctly aligns the cover with the central body element.

12. A window blind frame comprising a pair of frame members having adjacent ends that are joined together by a snap-fit corner bracket according to claim 1, wherein each frame member includes a wall which defines therein a slot, and a channel-defining portion which defines a channel, wherein the channel-defining portion is spaced from the wall; the locating member of a respective connector assembly is located within the channel defined by each frame member; an end face of each frame member contacts a respective one of the stop surfaces; the slot of each frame member wall receives therein a respective engagement lug; and the skirts cover the respective end portions of the frame members.

13. A window blind frame according to claim 12, wherein the frame comprises four frame members having a rectangular arrangement, and wherein adjacent ends of the frame members are joined together by respective corner brackets.

14. A combination of a window blind frame according to claim 12 and a window blind, wherein the window blind is secured to the window blind frame.

15. A combination according to claim 14, wherein the window blind is a roller blind, a vertical blind, a Venetian blind, a Roman blind, a cellular blind or a pleated blind.

16. A combination of a window blind frame according to claim 13 and a window blind, wherein the window blind is secured to the window blind frame.

17. A snap-fit corner bracket according to claim 10, wherein the central body element includes two spaced-apart first cover connectors; and the cover includes two corresponding spaced apart second cover connectors, wherein the interengagement of the first cover connectors with the respective second cover connectors correctly aligns the cover with the central body element.
